(19) United States
(12) Patent Application Publication
(10) Pub. No.: US 2011/0263161 A1
(43) Pub. Date: Oct. 27, 2011

(54) FUSE ADAPTER

(75) Inventor: ANDREW JOSEPH JOZWIAK, EL PASO, TX (US)

(73) Assignee: DELPHI TECHNOLOGIES, INC., Troy, MI (US)

(21) Appl. No.: 12/764,618

(22) Filed: Apr. 21, 2010

(51) Int. Cl. H01R 27/02; H01R 13/04

(52) U.S. Cl. 439/651; 439/884

(57) ABSTRACT

A fuse adapter adapts coplanar blades of fuse having a predetermined blade spacing to fit a pair of coplanar blade receiving terminal slots in a circuit having a different slot spacing. The fuse adapter includes a pair of adapter terminals. Each adapter terminal has a slotted, planar upper end spaced from the other terminal's slotted upper end by the fuse blade spacing. Each adapter terminal upper end also has an adjusting tab bent away from the upper end substantially perpendicular thereto and substantially parallel to the plane of the coplanar terminal slots. Each adjusting tab is integral with a transition portion that extends to an adapter blade. The two adapter blades are coplanar with and spaced apart to match the fuse blade receiving terminal slots in the circuit.

### TECHNICAL FIELD

This invention is directed to a fuse adapter. More particularly, the fuse adapter adapts coplanar blades of a fuse having a predetermined spacing to fit a pair of coplanar receiving terminal slots having a different slot spacing.

### BACKGROUND OF INVENTION

It is known, according to U.S. Pat. No. 6,726,506 issued on Apr. 27, 2004 and referring to prior art FIGS. 1 and 2, to use a fuse holder 1 mounted to a printed circuit board 2 that holds a fuse 3 in a fuse holder 1. The fuse 3 is used in an electric circuit (not shown) disposed on a printed circuit board 2. The fuse holder 1 includes connecting parts 4 to receive blade terminals 5 in connection with a body 6 of a fuse 3. Connecting parts 4 disposed in the fuse holder 1 are in electrical connection with corresponding contacts 7. Contacts 7 are mounted to a printed circuit board 2 to connect fuse 3 with the electric circuit (not shown). Each blade terminal 5 has a centerline and a corresponding width between the centerlines of the blade terminals 5. The width of the blade terminals 5 of the fuse 3 is the same width between a centerline on each of the contacts 7 mounted to the circuit board 2.

Vehicle electrical/electronic content continues to increase while the packaging for this electrical content continues to decrease requiring smaller fuse devices, or fuse circuit elements to support the increased electrical content. For example, five millimeter fuses will soon be employed in vehicle power distribution systems. These are so called due to a 5 millimeter centerline-to-centerline spacing. Five millimeter fuses may not be commonly available to consumers wanting to replace a blown fuse. Wider fuses, such as 8.2 millimeter fuses, are more generally available.

Therefore, what is needed is reliable fuse adapter that mates a commonly available wider fuse to a narrower fuse spacing.

### SUMMARY OF THE INVENTION

According to one aspect of the invention, a fuse adapter is provided to adapt a fuse having a pair of coplanar blades with a predetermined blade spacing to fit to a pair of coplanar blade receiving terminal slots in a circuit having a different slot spacing. The fuse adapter includes a pair of adapter terminals. An upper end of each adapter terminal is spaced apart by the predetermined fuse blade spacing. Each upper end of the adapter terminals also has an adjusting tab bent away from the upper end substantially perpendicular thereto and substantially parallel to the plane of the coplanar receiving terminal slots. Each adjusting tab is integral with a transition portion on the adapter terminal that extends to an adapter blade. The two adapter blades on the respective adapter terminals are coplanar with and are spaced apart to match the fuse blade receiving terminal slots in the circuit.

According to an another aspect of the invention, a multi-fuse adapter includes a pair of adapter terminals and a center adapter terminal that cooperate to adapt a plurality of fuses each of which have coplanar blades with a predetermined blade spacing to fit with corresponding blade receiving terminal slots having a different slot spacing between each blade receiving terminal slot.

In still yet another aspect of the invention, a terminal is provided that includes at least one slotted, planar upper end, an adjusting tab in connection with the at least one upper end, a transition portion extending away from the adjusting tab, and an adapter blade in connection with the transition portion.

### BRIEF DESCRIPTION OF THE DRAWINGS

This invention will be further described with reference to the accompanying drawings in which:

FIG. 1 is a cross section front view of a prior art fuse holder;

FIG. 2 is a cross section side view of the prior art fuse holder of FIG. 1;

FIG. 3 is an exploded, perspective view of a fuse being inserted into the fuse adapter in accordance with an exemplary embodiment of the invention, and the fuse adapter fitted with the fuse is subsequently inserted into a receptacle of an electrical center;

FIG. 4 is a perspective view of the fuse adapter of FIG. 3 showing inner terminal arrangement details thereof, and the fuse and the housing are shown in phantom line;

FIG. 5 is a perspective view of the terminal arrangement of the multi-fuse adapter showing the details thereof, according to an another exemplary embodiment of the invention, and the fuse and the housing are shown in phantom line.

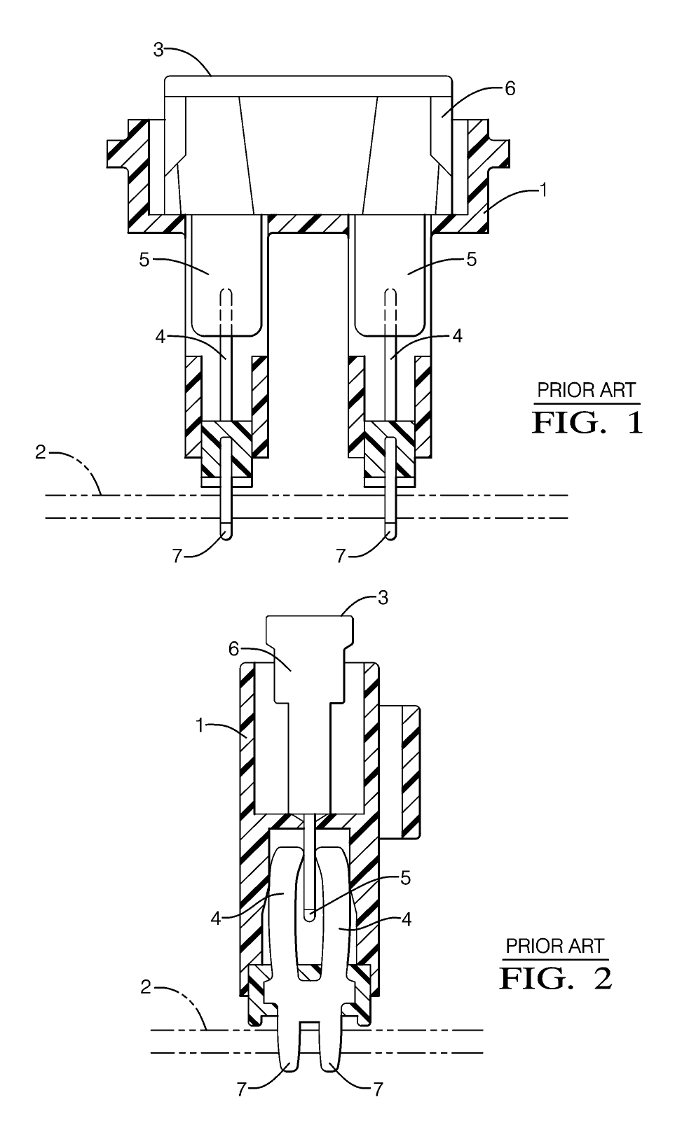

### DETAILED DESCRIPTION

Disclosed herein is a fuse adapter that receives a fuse containing coplanar blade terminals having a predetermined spacing and adapts the predetermined spacing to fit in blade receiving terminals having a different spacing between the blade receiving terminals such as may be found in an electrical center or circuit board. Once the fuse adapter is installed in the electrical center with the fuse received in the fuse adapter, the received fuse electrically operates as an active circuit element in an electronic circuit. A multi-fuse adapter is also disclosed that receives a plurality of fuses that each have coplanar blade terminals having a predetermined blade spacing and the multi-fuse adapter adapts each fuse in the plurality of fuses to blade receiving terminals that have a different spacing from the predetermined blade spacing between each blade receiving terminal. The fuse adapter and multi-fuse adapter may be configured to receive commonly available fuses having amperage sizes that are widely commercially available for use in motor vehicle applications and consumer electronics.

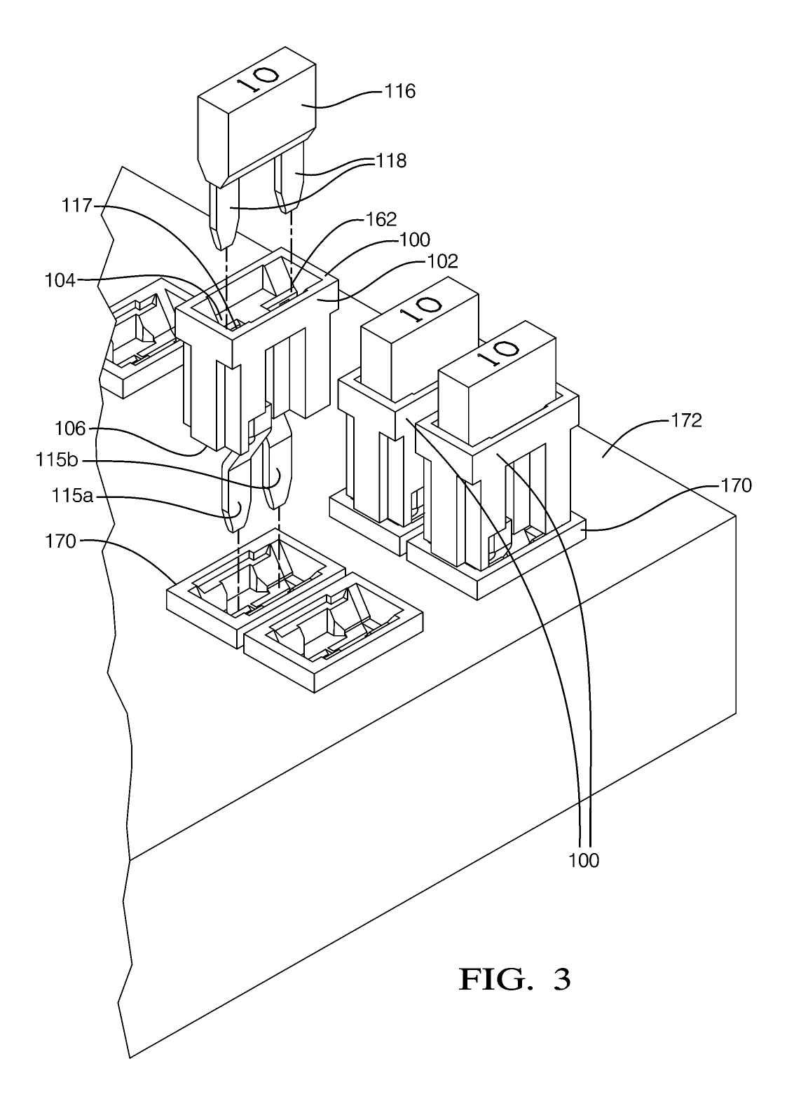

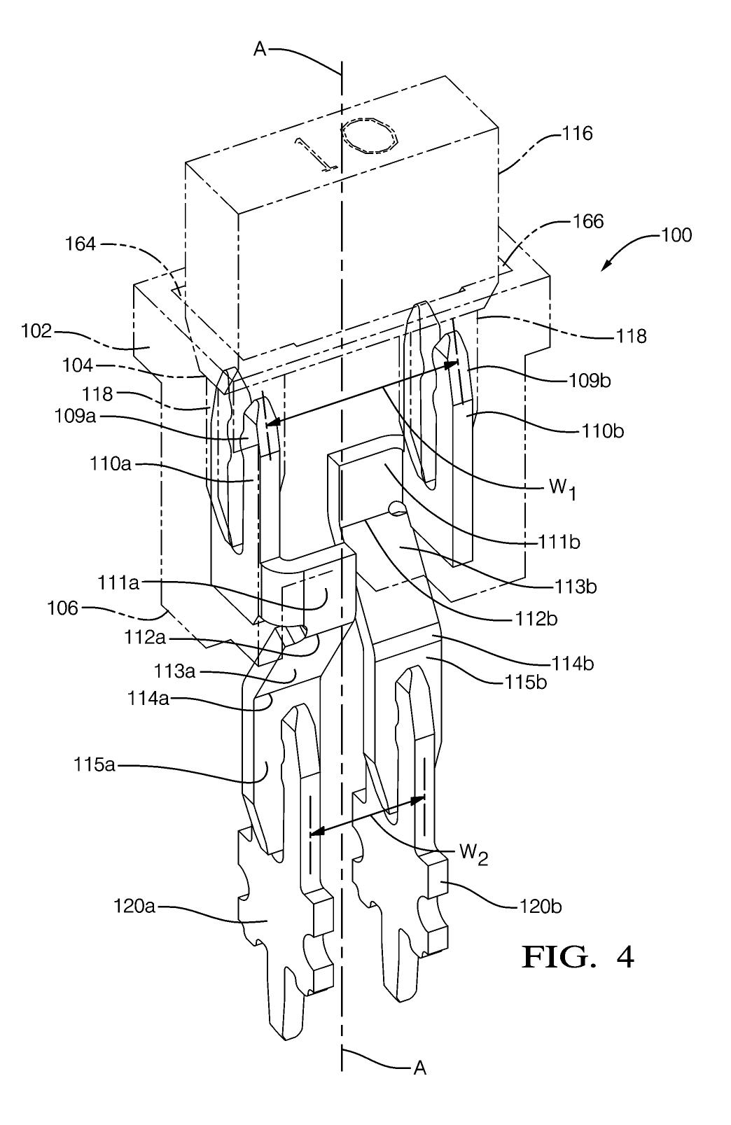

Referring now to the drawings where like numerals indicate like or corresponding parts throughout the views and exemplary embodiments are illustrated. Referring to FIGS. 3 and 4, fuse adapter 100, according to the invention, is populated in a receptacle 170 in an electrical center 172. As illustrated, electrical center 172 includes a plurality of fuse adapters including received fuses therein. A fuse receiving end 104 of fuse adapter 100 receives a fuse 116 containing blade terminals 118 having a predetermined centerline-to-centerline blade spacing, or a first width w₁ between blade terminals 118 and adapts this to fit a different spacing, or a second width w₂ between the receiving terminal slots in receptacle 170 of electrical center 172. Fuse adapter 100, including received fuse 116 in cavity 164, is inserted into receiving terminals 120a, 120b disposed in corresponding receiving terminal slots for a circuit (not shown) in electrical connection with receptacle 170.

Referring to FIG. 4, fuse adapter 100 includes a housing 102 disposed along a longitudinal axis A. Housing 102 includes fuse receiving end 104 and a terminal end 106 axially remote from fuse receiving end 104. Housing 102 is formed of an electrically nonconductive material, preferably a material such as a plastic resin, a thermoplastic, and the like.

A pair of adapter terminals 109a, 109b are disposed axially in housing 102. One of the pair, or first adapter terminal 109a is an integral terminal that includes a slotted, planar upper end 110a, an adjusting tab 111a, a transition portion 113a, and an adapter blade 115a. Upper end 110a defines a slot forming a tuning fork-type shape that allows upper end 110a to receive blade terminal 118. Adjusting tab 111a is bent away from upper end 110a substantially perpendicular to upper end 110a. Adjusting tab 111a is integral with transition portion 113a and transition portion 113a extends in a direction away from adjusting tab 111a. Adapter blade 115a is in connection with transition portion 113a. Adapter blade 115a axially extends in a direction away from transition portion 113a. Transition portion 113a also extends away from terminal end 106 of housing 102. A first bend 112a forms a transition interface between adjusting tab 111a and transition portion 113a. A second bend 114a forms another transition interface between transition portion 113a and adapter blade 115a. First adapter terminal 109a is electrically conducting and is formed by a stamping manufacturing operation from a sheet of metal base material made of plated or unplated copper alloy, and the like. Additional forming and bending manufacturing operations on the stamped metal piece configures the metal piece into first adapter terminal 109a as discussed herein. A first aperture 117 is defined in housing 102 proximate upper end 110a disposed within cavity 164 at fuse receiving end 104. Aperture 117 provides access to receive blade terminal 118 of fuse 116 from outside housing 102 to connect with upper end 110a.

Another one of the pair of adapter terminals, or second adapter terminal 109b is also disposed in housing 102. Second adapter terminal 109b is identical to first adapter terminal 109a and is formed from material and constructed like first adapter terminal 109a, as described previously herein. Using the identical terminal for both adapter terminals may decrease design and manufacturing costs for the fuse adapter. Elements of second adapter terminal 109b that are similar to first adapter terminal 109a have similar element numbers that differ by a similar, different letter designator. Second adapter terminal 109b is spaced apart from first adapter terminal 109a in a direction perpendicular to axis A. Second adapter terminal 109b also includes a slotted, planar upper end 110b, an adjusting tab 111b, a transition portion 113b, and an adapter blade 115b, and bends 112b, 114b. A second aperture 162 is defined in fuse receiving end 104 to provide access to upper end 110b of second adapter terminal 109b from outside of housing 102 similar to first aperture 117. Adapter terminals 109a, 109b are configured in housing 102 with a centerline-to-centerline spacing between upper end 110a and upper end 110b being first width w₁ which matches the predetermined centerline-to-centerline spacing between blade terminals 118 of fuse 116. Adapter terminals 109a, 109b are also configured in housing 102 such that adapter blades 115a, 115b are spaced apart by second width w₂ and are coplanar to match with coplanar receiving terminals 120a, 120b in receiving slots of electrical center 172. Housing 102 is configured around terminals 109a, 109b to ensure terminals 109a, 109b maintain first width w₁ and second width w₂. Adjusting tabs 111a, 111b are substantially parallel with the plane of coplanar adapter blades 115a, 115b.

First adapter terminal 109a has a first orientation in housing 102 and second adapter terminal 109b has a second orientation different from the first orientation in housing 102. The second orientation includes second adapter terminal 109b being rotated, or mirrored about the plane of coplanar receiving terminals 120a, 120b. Thus, terminal 109b is rotated about the plane receiving terminals 120a, 120b being 180 degrees out of phase with terminal 109a. Thus, upper end 109a mirrors upper end 109b and adjusting tabs 111a, 111b have a mirroring opposing relationship through axis A in housing 102. Upper ends 110a, 110b of first and second adapter terminals 109a, 109b are adapted to receive blade terminals 118 of blade-type fuse 116.

Cavity 164 of housing 102 is defined in fuse receiving end 104 and overlies first and second adapter terminal 109a, 109b. Cavity 164 includes an open end 166 adjacent fuse receiving end 104. Open end 166 is configured to receive a body of fuse 116 upon insertion of blade terminals 118 through apertures 117, 162 in cavity 164. Cavity 164 provides a cradle for the body of fuse 116.

Housing 102 of fuse adapter 100 has a rectangular shape about axis A. Alternately, the housing may be formed of any desired shape. Preferably, the fuse adapter may be manufactured with the first adapter terminal being fitted, or inserted into the first aperture and the second adapter terminal being fitted, or inserted into the second aperture in the housing. After insertion of the terminals into the housing, the housing deflects around the terminals to snap-lock and secure the terminals in place, as is known in the art. Alternately, the terminals may be press-fit into the apertures in the housing. Housing 102 is configured to enclose and secure at least upper ends 110a, 110b of first and second adapter terminal 109a, 109b. Housing 102 is configured to assist in maintaining the centerline-to-centerline spacing of first width w₁ between the upper ends 110a, 110b and the centerline-to-centerline spacing of second width w₂ of adapter blades 115a, 115b. Still yet alternately, the fuse adapter may be manufactured with the housing being molded around the first and the second adapter terminal.

Housing 102 defines first width w₁ perpendicular to axis A between a centerline-to-centerline spacing of upper ends 110a, 110b. Housing 102 defines second width w₂ perpendicular to axis A between a centerline-to-centerline spacing of adapter blades 115a, 115b that match the different spacing between receiving terminals 120a, 120b of electrical center 172. First width w₁ is not the same width as second width w₂. Alternately, first width w₁ is greater than second width w₂. Preferably, width w₁ is about 8.2 millimeters and width w₂ is about 5 millimeters. The 8.2 millimeter width between blade terminals of the fuse is associated with fuses that are commonly commercially available in the marketplace for purchase at locations like retail part supply outlets. Thus, a commonly available 8.2 millimeter fuse may be used in product applications with the fuse adapter to fit a 5 millimeter fuse terminal spacing that would not otherwise accommodate the 8.2 millimeter fuse. Still yet alternately, width w₁ is substantially 8.2 millimeters and width w₂ is substantially 5 millimeters. The fuse adapter may be used in any application requiring a fuse having a first width to be implemented in a product application having a second width that is not the same as the first width. The fuse adapter may find widespread use in many electrical/electronic applications in the transportation, agriculture, and marine industries.

When blade terminals 118 of fuse 116 are received in slots of upper ends 110a, 110b of first and second adapter terminal 109a, 109b, blade terminals 118 in the slots of upper ends 110a, 110b have a coplanar relationship with adapter blades 115a, 115b. Adjusting tabs 111a, 111b and transition portions 113a, 113b are not in the plane defining the coplanar relationship between upper ends 110a, 110b and adapter blades 115a, 115b. Adjusting tabs 111a, 111b, transition portions 113a, 113b, and bends 112a, 112b, 114a, 114b cooperate to allow blade terminals 118 of fuse 116 received in slots of upper ends 110a, 110b and adapter blades 115a, 115b to have a coplanar relationship while also allowing first width w₁ to not be the same width as second width w₂.

Referring to FIG. 3, when adapter blades 115a, 115b of first and second adapter terminal 109, 109b are not in electrical connection with fuse receiving terminals 120a, 120b, fuse adapter 100 is not in use and does not electrically operate. Referring to FIGS. 3 and 4, fuse adapter 100 is in use when adapter blades 115a, 115b of first and second adapter terminal 109a, 109b are in electrical connection with fuse receiving terminals 120a, 120b in receptacle 170, such as when fuse adapter 100 is inserted and received into a receptacle 170 of a fuse block, or electrical center 172. If fuse 116 is not received in upper ends 110a, 110b when adapter blades 115a, 115b are installed in fuse receiving terminals 120a, 120b, the fuse adapter does not affect electrical operation in an electrical circuit (not shown) electrically connected with receiving terminals 120a, 120b. Insertion of fuse 116 through apertures 117, 162 in fuse receiving end 104 allow for electrical connection of blade terminals 118 with upper ends 109a, 109b of adapter terminals 109a, 109b of fuse adapter 100 such that fuse adapter 100 does electrically operate with receiving terminals 120a, 120b. Electrical connection of fuse 116 in fuse adapter 100 ensures electrical connection with receiving terminals 120a, 120b and the electrical circuit (not shown) in electrical communication with electrical center 172. Alternately, the fuse may be initially inserted into the fuse adapter followed by the fuse adapter with the received fuse being inserted in to the receptacle of the electrical center.

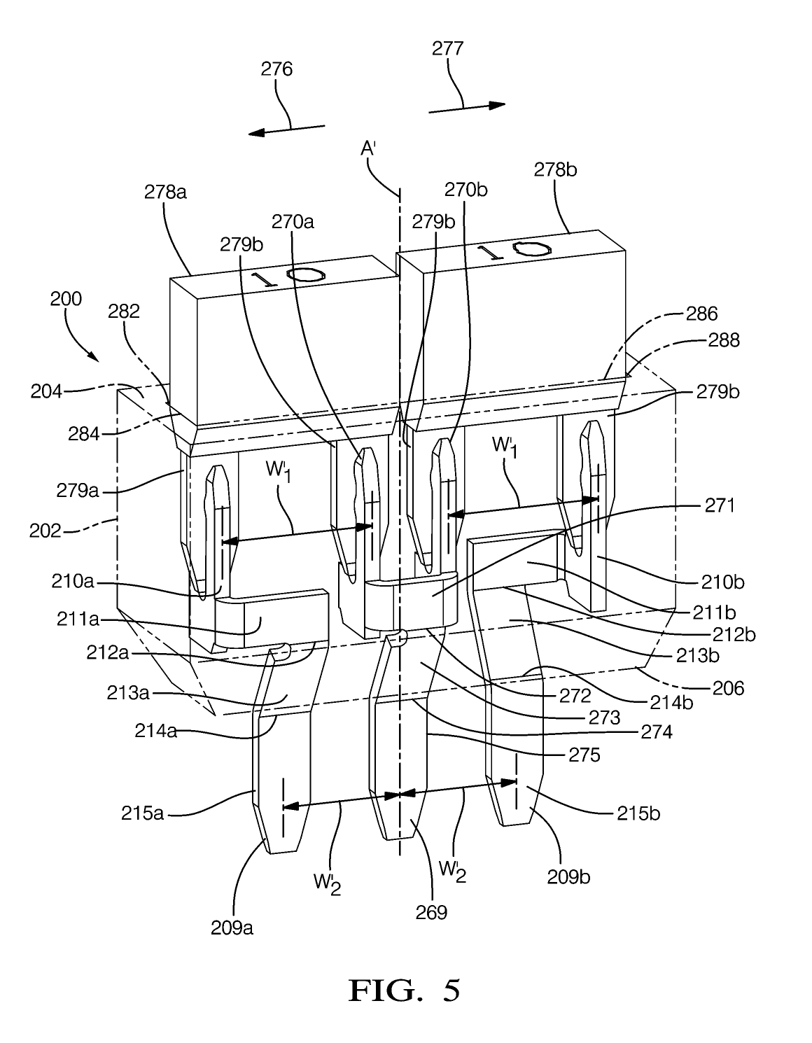

Referring to FIG. 5, in accordance with another embodiment of the invention, a multi-fuse adapter 200 is provided. Where the structure of multi-fuse adapter 200 in the embodiment of FIG. 5 is similar with the structure of fuse adapter 100 in the embodiment of FIG. 4, element numbers are marked differing by 100 and are previously described herein. Multi-fuse adapter 200 includes a housing 202 disposed along a longitudinal axis A′, a first and a second adapter terminal 209a, 209b, and a center adapter terminal 269. Multi-fuse adapter 200 has a similar construction to the embodiment of FIG. 4 previously described herein. Multi-fuse adapter 200 may be useful when two or more fuses are needed for electrical connection with corresponding adjacent fuse receiving terminals in a fuse electrical center or circuit board where a first width w₁′ of the predetermined spacing of each of the fuses is not the same width as a different spacing, or second width w₂′ between each of the fuse receiving terminals.

Center adapter terminal 269 is coaxially disposed in housing 202 intermediate first adapter terminal 209a and second adapter terminal 209b. Center adapter terminal 269 is formed by a stamping manufacturing operation similar to the embodiment of FIG. 4. Additional forming and bending manufacturing operations on the stamped metal piece further configures center adapter terminal 269 as discussed herein. First adapter terminal 209a is spaced apart from center adapter terminal 269 in a first direction 276 and second adapter terminal 209b is spaced apart from center adapter terminal 269 in a second direction 277 opposite first direction 276. First adapter terminal 209a is identical with second adapter terminal 209b. Center adapter terminal 269 includes a pair of slotted, planar upper ends 270a, 270b. Upper ends 270a, 270b are in connection with an adjusting tab 271 adjoining upper ends 270a, 270b. Adjusting tab 271 is in connection with transition portion 273 disposed about midway between upper ends 270a, 270b. Adapter blade 275 is in connection with transition portion 273 and remote from upper ends 270a, 270b. A first and a second aperture (not shown) are defined in fuse receiving end 204 to allow blade terminals 279a, 279b of fuses 278a, 278b to access the corresponding upper ends 210a, 210b of adapter terminals 209a, 209b. A third aperture (not shown) is also defined in fuse receiving end 204 to provide access to allow blade terminals 279a, 279b of fuses 278a, 278b to be received in upper ends 270a, 270b. Alternately, the third aperture may further include a third aperture to access upper end 270a in first cavity 284 and a fourth aperture to access other upper end 270b in second cavity 288. Cavities 284 and 288 combine to form a single cavity in an open end 282. Alternately, the housing may contain distinct cavities that receive the plurality of fuses. Each cavity may be separated from other cavities in the housing by a portion of the housing. Transition portion 273, in connection with adapter blade 275 of center adapter terminal 269, protrudes away from housing 202 at terminal end 206. Terminals 209a, 269, 209b are constructed into housing 202 in a similar manner as the first and the second adapter terminal as previously described in the embodiment of FIG. 4. Housing 202 is configured to enclose at least upper ends 210a, 270a, 270b, 210b of adapter terminals 209a, 269, 209b.

Each fuse 278a, 278b has corresponding coplanar blades 279a, 279b having a predetermined blade spacing, or a first width w₁′. Coplanar blade receiving terminal slots (not shown) have a different spacing from first width w₁′ between each slot in the plurality of receiving slots which is a second width w₂′. The centerline-to-centerline spacing between upper end 210a and upper end 270a is first width w₁′ which is the same as the predetermined centerline-to-centerline spacing of blade terminals 279a of first fuse 278a. The centerline-to-centerline spacing between upper end 270b and upper end 210b is first width w₁′ which is the same as the predetermined centerline-to-centerline spacing of blade terminals 279b of second fuse 278b. Likewise, the centerline-to-centerline spacing between adapter blade 215a and adapter blade 275 is second width w₂′ and the centerline-to-centerline spacing between adapter blade 275 and adapter blade 215b is also second width w₂′ which matches the different spacing between blade receiving terminals (not shown) in the receiving terminal slots (not shown). First width w₁′ is not the same width as second width w₂′. Preferably, first width w₁′ is greater than second width w₂′. More particularly, first width w₁′ is 8.2 millimeters and second width w₂′ is 5 millimeters for the reasons previously described herein in the embodiment of FIG. 4. Alternately, first width w₁′ is substantially 8.2 millimeters and second width w₂′ is substantially 5 millimeters. Adjusting tabs 211a, 271, 211b are substantially parallel with the plane of coplanar adapter blades 215a, 275, 215b and receiving terminals (not shown). Housing 202 cooperates with adapter terminals 209a, 269, 209b to maintain the spacing of first width w₁′ and second width w₂′. Adjusting tabs 211a, 271, 211b, transition portions 213a, 273, 213b, and bends 212a, 272, 212b, 214a, 274, 214b all cooperate to allow blade terminals 279a, 279b of fuses 278a, 278b received in slots in upper ends 210a, 270a, 270b, 210b and adapter blades 215a, 275, 215b to have a coplanar relationship while allowing first width w₁′ to not be the same width as second width w₂′.

Insertion of first fuse 278a through open end 282 of a first cavity 284 and through the first and the third aperture (not shown) in fuse receiving end 204 allows electrical connection of blade terminals 279a of first fuse 278a with the slot in upper end 210a on first adapter terminal 209a and the slot in upper end 270a on center adapter terminal 269. The body of first fuse 278a is subsequently cradled in first cavity 284 overlying upper ends 210a, 270a of respective first and center adapter terminal 209a, 269. Insertion of second fuse 278b through an open end 286 of a second cavity 288 and through second and the third aperture (not shown) in fuse receiving end 204 allows electrical connection of blade terminals 279b of second fuse 278b with the slot in upper end 270b on center adapter terminal 269 and the slot in upper end 210b on second adapter terminal 209b. The body of second fuse 278b is subsequently cradled in second cavity 288 overlying upper ends 270b, 210b of respective center and second adapter terminal 269, 209b.

Referring to FIG. 5, the slots in upper ends 210a, 270a, 270b, 210b are in coplanar relationship with adapter blades 215a, 275, 215b and adjusting tabs 211a, 271, 211b and transition portions 213a, 273, 213b are not in the coplanar relationship. The center adapter terminal may typically be in electrical connection with a power source electrically connected with the electrical center and common to both fuses received in the fuse adapter.

First adapter terminal 209a has a first orientation in housing 202 and second adapter terminal 209b has a second orientation in housing 202. One of the pair of adapter terminals 209b is mirrored about the plane of the receiving terminal slots (not shown) in housing 202 in relation to the other one of the pair of adapter terminals 209a. Thus, one of the pair of adapter terminals 209b is disposed in the housing rotated, or mirrored 180 degrees out of phase with the other one of the pair of adapter terminals 209a.

Alternately, the upper ends on the adapter terminals may be formed and configured to any shape that receives a terminal of a fuse. More particularly, the upper end may include any female-type configuration that receives a bladed device. For example, the upper end may be configured as a blade-type terminal that is configured to be fitted with a female-to-female device. A blade-type terminal of a fuse may then be received into the other end of the female-to-female device.

Yet alternately, the adapter blades of the terminals of the fuse adapter may be configured to be any shape that may be received by an electrical center or circuit board device, and the like. More particularly, the adapter blades may include any male-type configuration that is inserted into electrical center or circuit board device, and the like.

In another alternate embodiment, one or more of the terminals in the fuse adapter and multi-fuse adapter may each have different design constructions.

In a further alternate embodiment, the terminals of the fuse adapter and the multi-fuse adapter may be utilized without a housing in a product application to receive the fuses and directly connect into an electrical center or printed circuit board.

In yet another alternate embodiment, the bare adapter terminals of the fuse adapter and multi-fuse adapter may be separated by any spacing means different from a housing to ensure the predetermined blade spacing between blades of a fuse and/or the different slot spacing of the receiving terminal slots is maintained. For example, a plastic rib may join the adapter terminals together to assist to maintain the different spacing between the blade receiving terminals while the fuse is inserted into the upper ends to maintain the predetermined spacing of the blade terminals of the fuse.

In another alternate embodiment, the bare adapter terminals may be used without any structure to receive fuses and be directly inserted into the receiving terminals in the receiving terminal slots of an electrical center.

In a further alternate embodiment, the upper ends of the fuse adapter and multi-fuse may be further configured to allow the fuse adapter and the multi-fuse adapter to receive different fuse types such as mini-type or maxi-type fuses, low profile fuses, and the like.

In an another alternate embodiment, adapter blades of a fuse and a multi-fuse adapter may be further configured to mount the fuse adapter to structures other than electrical centers where electrical circuits are employed, such as printed circuit boards, and the like.

In another further alternate embodiment, a multi-fuse adapter may be configured to receive and electrically connect more than two fuses with circuits electrically connected with an electrical center or printed circuit board.

In yet another further alternate embodiment, the disposition of the upper ends of the center adapter terminal relative to each other on the multi-fuse adapter may be further adapted to form a plurality of configurations in cooperation with the placement of the respective first and second adapter terminals in the housing dependent on the product application. For example, if one of the upper ends of the center adapter terminal is offset from the other upper end of the center adapter terminal in a direction perpendicular to the axis, and the upper end of the first adapter terminal is aligned with one of the upper ends of the center adapter terminal and the upper end of the second adapter terminal is aligned with the other upper end of the center adapter terminal, this configuration allows placement of a first fuse in the receiving fuse end of the multi-fuse adapter to be offset from the second fuse in the receiving fuse end of the multi-fuse adapter. This configuration may then be fitted into receiving terminals of an electrical center that are similarly offset. Other configurations in the plurality of the configurations are left to the artesian.

Thus, the invention provides for a reliable fuse adapter that receives a commonly available fuse having a predetermined spacing, or a first width between the blade terminals of the fuse and adapts the predetermined spacing to a different spacing, or a second width between each of the blade receiving terminals in an electrical center. A commonly available 8.2 millimeter fuse, used in conjunction with the fuse adapter, allows the larger 8.2 millimeter fuse to service a blown fuse having a narrower five millimeter fuse receiving terminal slot spacing in an electrical center. Utilizing adapter blades on the first and second adapter terminal of the fuse adapter allows the fuse adapter to directly fit into receiving terminals in a receptacle of an electrical center. The orientation of the adapter terminals in the housing using a single terminal design eliminates the need to manufacture other additional terminal designs so as to reduce design and manufacturing costs for the fuse adapter. Fitted construction of the adapter terminals within the housing provides ease of manufacturing of the fuse adapter. The fuse adapter may be utilized for connection to electrical centers and circuit boards, and the like, wherever a fuse circuit element needs to be employed where blade terminals on the fuse having the predetermined spacing adapt to a different spacing between each receiving terminal. Slots in the upper ends of the adapter terminals are coplanar with the adapter blades of the adapter terminals to allow an insertion force of the fuse adapter into an electrical center or circuit board to be concentrated along a central plane with the receiving terminals in the electrical center to allow ease of insertion of the fuse adapter without additional stress being placed on the fuse or the adapter terminals in the housing of the fuse adapter. A multi-fuse adapter is provided to allow two or more fuses having blade terminals with a predetermined spacing of the first width to be received into the multi-fuse adapter and the multi-fuse adapter employed where additional fuse capability having a plurality of blade receiving terminals with a different spacing between each of the receiving terminals being the second width is required.

While the present invention has been shown and described with reference to certain preferred embodiments thereof, it will be understood by those skilled in the art that various changes in form and details may be made therein without departing from the spirit and scope of the present invention as defined by the appended claims.

All terms used in the claims are intended to be given their broadest ordinary meanings and their reasonable constructions as understood by those skilled in the art unless an explicit indication to the contrary is made herein. In particular, use of the singular articles such as “a,” “the,” “said,” . . . et cetera, should be read to recite one or more of the indicated elements unless a claim recites an explicit limitation to the contrary.

1. A fuse adapter for adapting a fuse having a pair of coplanar blades with a predetermined blade spacing to fit to a pair of coplanar blade receiving terminal slots in a circuit having a different slot spacing, comprising:
a pair of adapter terminals, each adapter terminal having a slotted, planar upper end spaced from the other terminal's slotted upper end by said predetermined blade spacing, each adapter terminal upper end also having an adjusting tab bent away from the upper end substantially perpendicular thereto and substantially parallel to a plane defined through the coplanar terminal slots, each adjusting tab being integral with a transition portion that extends towards and directly connects with to an adapter blade, the two adapter blades being coplanar with and spaced apart by said different slot spacing to match the blade receiving terminal slots in said circuit.

2. The fuse adapter according to claim 1, wherein said predetermined blade spacing between the respective upper ends is greater than said different slot spacing between of the respective adapter blades.

3. The fuse adapter according to claim 2, wherein said predetermined blade spacing between the respective upper ends is about 8.2 millimeters and said different slot spacing between the respective adapter blades is about 5 millimeters.

4. The fuse adapter according to claim 1, further including,
a housing surrounding at least the upper ends of the pair of adapter terminals,
wherein the housing is adapted to ensure the pair of adapter terminals maintain said predetermined blade spacing between the upper ends and said different slot spacing between the adapter blades.

5. The fuse adapter according to claim 1, wherein one of the pair of adapter terminals is identical with the other one of the pair of adapter terminals.

6. The fuse adapter according to claim 1, wherein one of the pair of adapter terminals is mirrored about the plane of the receiving terminal slots in the housing in relation to the other one of the pair of adapter terminals, whereby the one of the pair of adapter terminals is disposed in the housing 180 degrees out of phase with the other one of the pair of adapter terminals.

7. The fuse adapter according to claim 1, wherein the slots in the upper ends of the pair of adapter terminals have a coplanar relationship with the adapter blades of the pair of adapter terminals.

8. The fuse adapter according to claim 7, wherein the adjusting tabs and the transition portions of the adapter terminals are not in the coplanar relationship.

9. A multi-fuse adapter for adapting a plurality of fuses where each fuse has a pair of coplanar blades with a predetermined blade spacing to fit with a plurality of coplanar blade receiving terminal slots in a circuit including a different slot spacing between each terminal slot, comprising:
a center adapter terminal including a pair of slotted, planar upper ends with one of the upper ends spaced apart from the other upper end by an adjusting tab joining the pair of upper ends, and the adjusting tab being bent away from each of the upper ends of the pair of upper ends substantially perpendicular thereto and substantially parallel to the plane of the coplanar terminal slots; and
a pair of adapter terminals with one adapter terminal spaced apart from the center adapter terminal in first direction and the other adapter terminal spaced apart from the center adapter terminal in a second direction opposite the first direction, and each adapter terminal having a slotted upper end being coplanar with the pair of upper ends on the center adapter terminal and each upper end of the pair of adapter terminals also having an adjusting tab bent away from the upper end of each adapter terminal substantially perpendicular thereto and substantially parallel to the plane of the coplanar terminal slots, each adjusting tab of the terminals being integral with a transition portion that extends to an adapter blade, the three adapter blades being coplanar with and spaced apart to match the plurality of blade receiving terminal slots in said circuit.

10. The multi-fuse adapter according to claim 9, wherein said predetermined blade spacing is greater than said different slot spacing.

11. The multi-fuse adapter according to claim 10, wherein said predetermined blade spacing is about 8.2 millimeters and said different slot spacing is about 5 millimeters.

12. The multi-fuse adapter according to claim 9, further including,
a housing surrounding at least the pair of upper ends of the center adapter terminal and the upper ends of the pair of adapter terminals,
wherein the housing is adapted to ensure the center adapter terminal and the pair of adapter terminals maintain the predetermined blade spacing and the different slot spacing.

13. The multi-fuse adapter according to claim 12, wherein the housing defines one of a cavity and a plurality of cavities to receive the plurality of fuses.

14. The multi-fuse adapter according to claim 9, wherein one of the pair of adapter terminals is identical with the other one of the pair of adapter terminals.

15. The fuse adapter according to claim 9, wherein one of the pair of adapter terminals is mirrored about the plane of the receiving terminals slots in the housing in relation to the other one of the pair of adapter terminals, whereby the one of the pair of adapter terminals is disposed in the housing 180 degrees out of phase with the other one of the pair of adapter terminals.

16. The fuse adapter according to claim 9, wherein the slots in the upper ends of the pair of adapter terminals and the center adapter terminal are in a coplanar relationship with the adapter blades of the pair of adapter terminals and the center adapter terminal.

17. The multi-fuse adapter according to claim 16, wherein the adjusting tabs and the transition portions of the adapter terminals are not in the coplanar relationship.

18. A terminal comprising:
at least one slotted, planar upper end including an adjusting tab bent away from the at least one upper end substantially perpendicular thereto;
a transition portion extending away from the adjusting tab; and
an adapter blade,
wherein the transition portion directly connects the upper end with the adapter blade being disposed intermediate thereto.

19. The terminal according to claim 19, wherein the slot in the at least one upper end has a coplanar relationship with the adapter blade, and the adjusting tab and the transition portion are not in the coplanar relationship.
